(19) United States
(12) Patent Application Publication
(10) Pub. No.: US 2007/0217441 A1
(43) Pub. Date: Sep. 20, 2007

(54) Method and system for estimating co-channel interference in a frame of a block transmission system

(76) Inventors: Sriram Mudulodu, Santa Clara, CA (US); Parikshith Sreebhashyam, Santa Clara, CA (US); Krishnamurthy Giridhar, Santa Clara, CA (US); Sriram Rajagopal, Santa Clara, CA (US)

Correspondence Address: COMPANY: BECEEM COMMUNICATIONS, INC., 1ST FLOOR, 3960 FREEDOM CIRCLE, SAN JOSE, CA, 95054, US

(21) Appl. No.: 11/481,618

(22) Filed: Jul. 6, 2006

(30) Foreign Application Priority Data
Mar. 20, 2006 (IN) 390/MUM/2006

(51) Int. Cl. H04J 3/16

(52) U.S. Cl. 370/437

(57) ABSTRACT

A method and system for estimating Co-Channel Interference (CCI) at each pilot sub-carrier of each symbol in a frame of a block transmission system is provided. The method includes determining the CCI at each pilot sub-carrier of a predetermined number of symbols (L). The predetermined number of symbols is equal to the periodicity of the pilot pattern of the frame. The method includes using the CCI at each pilot sub-carrier of the predetermined number of symbols to estimate the CCI at each pilot sub-carrier of remaining symbols in the frame.

### RELATED APPLICATION DATA

This application claims priority to and incorporates by reference India provisional application serial number 390/MUM/2006 filed on Mar. 20, 2006, titled “Method and System for Estimating Co-Channel Interference in a Frame of a Block Transmission System”

### BACKGROUND

The invention generally relates to block transmission systems. More specifically, the invention relates to a method and system for estimating channel frequency response and Co-Channel Interference (CCI) in a frame of a block transmission system, which is a frequency reuse system.

In block transmission systems, pilot sub-carriers are provided to enable synchronization and also for channel estimation and tracking. In a frequency reuse system, users at the cell-edge and/or sector edge can experience CCI from undesired transmit antennas. In existing frequency reuse systems, the channel response of a pilot sub-carrier is estimated by neglecting the CCI corresponding to the pilot sub-carrier. However, the CCI may be significantly large and therefore can severely distort the estimation of the channel response.

There is therefore a need for a method and system that enables estimation of CCI at each pilot sub-carrier of each symbol in a frame of a block transmission system so as to improve the accuracy of the estimation of the channel response.

### SUMMARY

The systems and methods described below provide a method and system for estimating Co-Channel Interference at each pilot sub-carrier of each symbol in a frame of a block transmission system.

The systems and methods described below improve the accuracy of the estimation of the channel response.

The systems and methods described below include a method for estimating CCI at each pilot sub-carrier of each symbol in a frame of a block transmission system. The method includes determining the CCI at each pilot sub-carrier of a predetermined number of symbols (L). The predetermined number of symbols is approximately equal to the periodicity of the pilot pattern of the frame. The method includes using the CCI at each pilot sub-carrier of the predetermined number of symbols to estimate the CCI at each pilot sub-carrier of remaining symbols in the frame.

### BRIEF DESCRIPTION OF DRAWINGS

FIG. 1 is a flowchart for estimating co-channel interference (CCI) at each pilot sub-carrier of each symbol in a frame of a block transmission system, in accordance with an embodiment.

FIG. 2 is a flowchart for performing channel estimation, in accordance with an embodiment.

FIG. 3 is a flowchart for estimating CCI at each pilot sub-carrier of each symbol in a frame of the block transmission system, in accordance with another embodiment.

FIG. 4 is a flowchart for performing channel estimation, in accordance with another embodiment.

FIG. 5 is a block diagram of a system for performing channel estimation in a block transmission system, in accordance with an embodiment. [To Rick: Please note that, in light of your comments we have changed FIG. 5 to represent a block diagram. Further, a block transmission system represents an OFDM communication system. In light of this, FIG. 5A recommended by you would not be required.]

FIG. 6 is a comparison between Mean Square Error (MSE) performance of the method of an embodiment and a single channel estimator without interference cancellation known in the art.

### DETAILED DESCRIPTION OF THE DRAWINGS

Methods and systems for performing channel estimation are described below. The channel estimation is performed by a receiver in a block transmission system. Examples of a block transmission system include orthogonal frequency-division multiplexing (OFDM), multi-carrier code division multiple access (MC-CDMA) and discrete multi-tone (DMT). The block transmission system is a frequency reuse system. In various embodiments herein, block transmission is a frequency reuse-1 system.

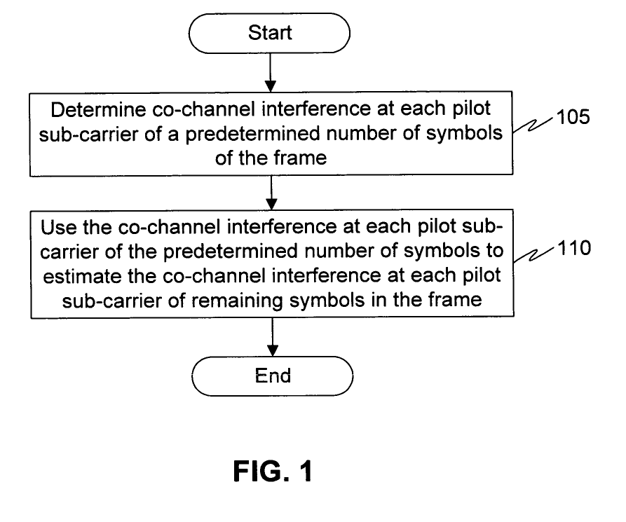

FIG. 1 is a flowchart for estimating co-channel interference (CCI) at each pilot sub-carrier of each symbol in a frame of a block transmission system, in accordance with an embodiment. In an embodiment, the frame is a downlink frame. In another embodiment, the frame is an uplink frame.

CCI is generally referred to as interference from undesired transmit antennas. If the frame is a downlink frame, the undesired transmit antennas may include transmit antennas of other base stations, and transmit antennas of other sectors of a desired base station. In an embodiment, CCI is represented as:

$$CCI ( i ) = {\sum }_{j = 1}^{J} {H}_{j} ( i ) {C}_{j} ( i ) \qquad ( 1 )$$

where,

J represents a total number of undesired transmit antennas;

Hⱼ represents the channel response of a j^{th} undesired base station at an i^{th} sub-carrier; and

Cⱼ represents the Pseudo-Noise(PN) code of the j^{th} undesired base station at the i^{th} sub-carrier of a symbol.

At 105, the CCI at each pilot sub-carrier of a predetermined number of symbols (L), is determined. In various embodiments, the predetermined number of symbols is approximately equal to the periodicity of the pilot pattern of the frame.

At 110, the CCI at each pilot sub-carrier of the predetermined number of symbols is used to estimate the CCI at each pilot sub-carrier of the remaining symbols in the frame. In an embodiment, the CCI at a pilot sub-carrier of a ‘k+L’ symbol is substantially equal to the CCI at the corresponding pilot sub-carrier of a ‘k’ symbol.

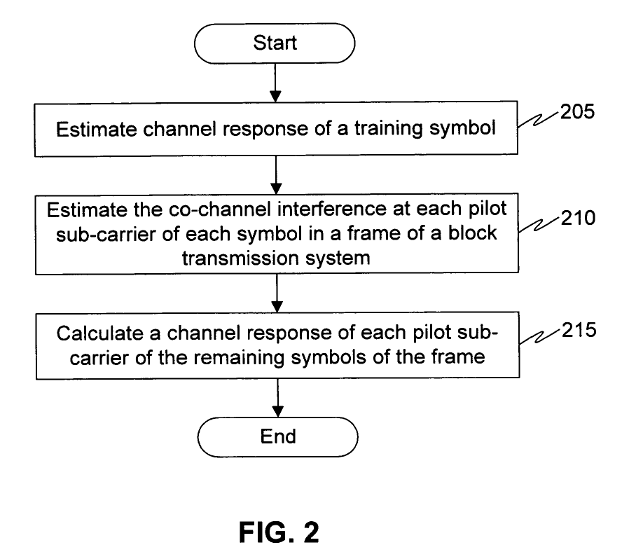

FIG. 2 is a flowchart for performing channel estimation, in accordance with an embodiment. The channel estimation is performed by a receiver in a block transmission system. In an embodiment, the frame is a downlink frame. In another embodiment, the frame is an uplink frame.

At 205, the channel response of a training symbol is estimated. In an embodiment, the training symbol is a preamble if the number of transmit antennas is approximately equal to one. In another embodiment, the training symbol is a mid-amble, if the number of transmit antennas is at least two. In various embodiments, the mid-amble is a segmented or reuse-1 mid-amble.

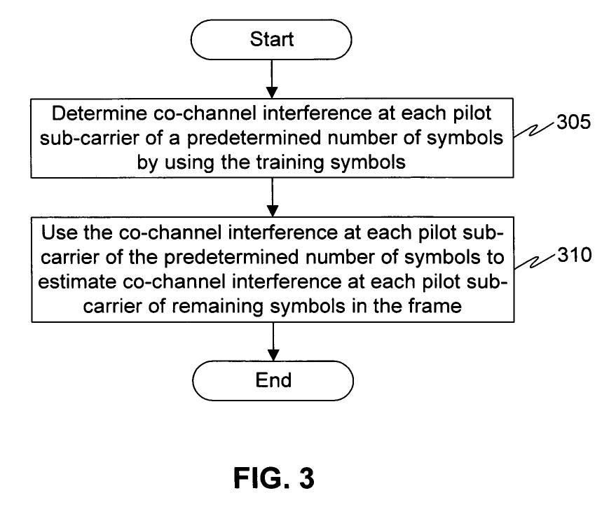

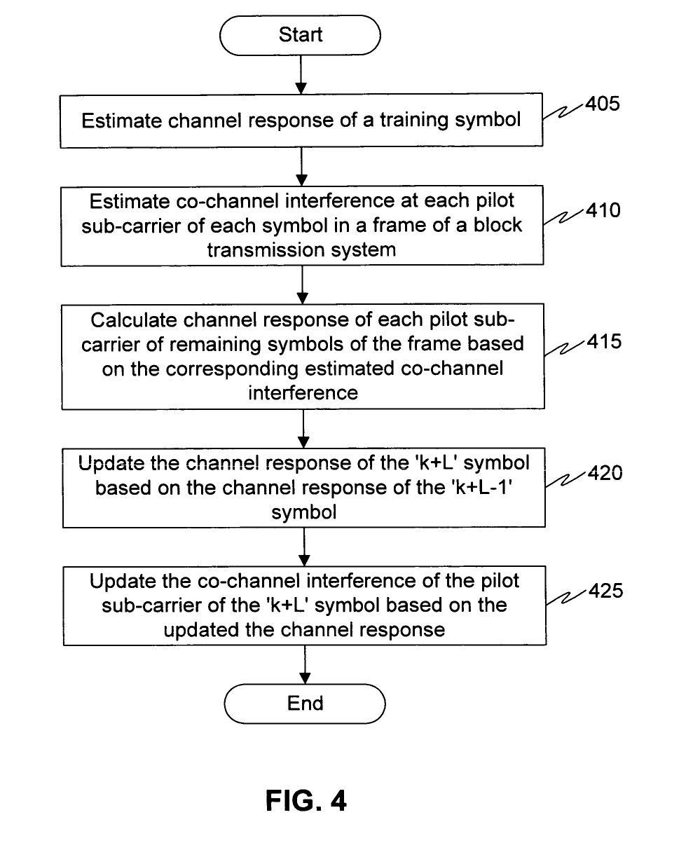

At 210, the CCI at each pilot sub-carrier of each symbol in a frame of the block transmission system is estimated. This is further explained below with reference to FIG. 3. The frame is transmitted by at least one transmit antenna. At 215, the channel response of each pilot sub-carrier of the remaining symbols of the frame is estimated based on the corresponding estimated CCI. In various embodiments, the channel response of each pilot sub-carrier of the remaining symbols of the frame is updated. This is further explained below with reference to FIG. 4.

FIG. 3 is a flowchart for estimating CCI at each pilot sub-carrier of each symbol in the frame of the block transmission system, in accordance with another embodiment.

At 305, the CCI at each pilot sub-carrier of a predetermined number of symbols (L) is determined using the training symbol. In various embodiments, the predetermined number of symbols (L) is approximately equal to the periodicity of the pilot pattern of the frame. In an embodiment, the CCI at each pilot sub-carrier of L symbols is estimated using equation 2:

CCIᵢ(k)=Rᵢ(k)−Ĥ₁(k)C₁ᵢ(k), i=1,2, . . . , L (2)

where,

Ĥ₁(k) represents the channel response of the training symbol at sub-carrier k;

C₁ᵢ(k) represents the PN code of the desired base-station at an k^{th} sub-carrier of a symbol i;

Rᵢ(k) represents the value of the k^{th} sub-carrier measured at the receiver at symbol i; and

CCIᵢ(k) represents the co-channel interference at the k^{th} sub-carrier of a symbol i;

In an embodiment, the CCI at each pilot sub-carrier of L symbols is determined using the product of the channel response of the training symbols and a predetermined function of fader rate of the receiver and difference in number of symbols from the training symbol. The predetermined function may be for example, a function for update of the channel response:

updater_function(F, k)=F^{k} (3)

where.

F represents a fading correlation from symbol to symbol; and

k represents difference in symbols for the update.

At 310, the CCI at each pilot sub-carrier of remaining symbols in the frame is estimated using the CCI at each pilot sub-carrier of the predetermined number of symbols. In an embodiment, each pilot sub-carrier in the frame is maximum length shift register (MLSR) sequence. Therefore, the CCI at a pilot sub-carrier of a ‘k+L’ symbol is approximately equal to the CCI at the corresponding pilot sub-carrier of a ‘k’ symbol as the pilot sub-carrier locations and consequently the PN codes at symbols k and k+L are identical. In another embodiment, the CCI at a pilot sub-carrier of a ‘k+L’ symbol is approximately equal to the product of the fader rate of the receiver and the co-channel interference at the corresponding pilot sub-carrier of a ‘k’ symbol.

FIG. 4 is a flowchart for performing channel estimation using a receiver in a block transmission system, in accordance with another embodiment.

At 405, the channel response of a training symbol is estimated. At 410, CCI is estimated at each pilot sub-carrier of each symbol in a frame of the block transmission system. At 415, the channel response of each pilot sub-carrier of the remaining symbols of the frame is calculated based on the corresponding estimated CCI.

At 420, the channel response of the ‘k+L’ symbol is updated based on the channel response of a ‘k+L−1’ symbol. In an embodiment, the channel response is updated by carrying out time domain processing on the channel response of the corresponding pilot sub-carrier of the ‘k+L−1’ symbol. Time domain processing may include Inverse Fast Fourier Transform (IFFT) of the channel response of the ‘k+L−1’ symbol, time domain windowing and truncation of the channel response of the ‘k+L−1’ symbol to a predefined length and the like.

At 425, the CCI of a pilot sub-carrier of the ‘k+L’ symbol is updated based on the updated channel response from 420.

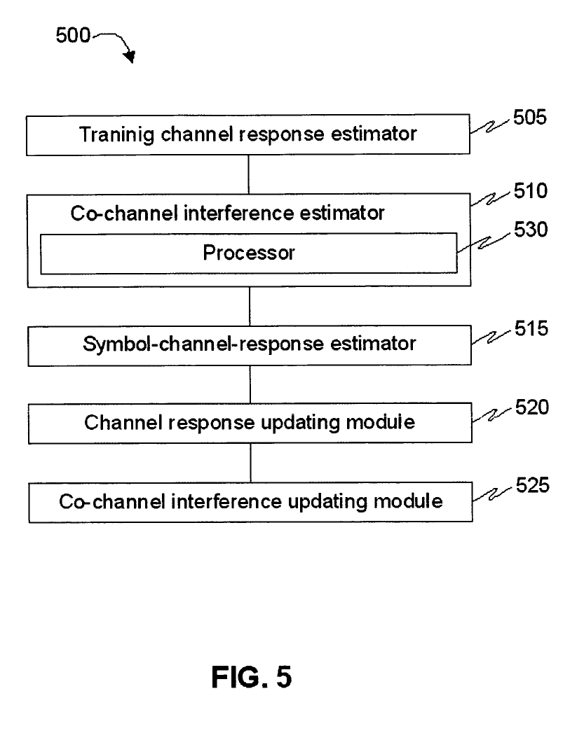

FIG. 5 is a block diagram of a system 500 for performing channel estimation in a block transmission system, in accordance with an embodiment. One or more components of the system 500 are configured to and/or are coupled to other components that are configured to perform the operations described above with reference to FIG. 1, FIG. 2, FIG. 3, and FIG. 4. System 500 is embedded in a receiver for example, but is not so limited. System 500 comprises a training-channel-estimator 505, a CCI estimator 510, a symbol-channel-response calculator 515, a channel response updating module 520, and a CCI updating module 525.

Training-channel-response estimator 505 estimates a channel response of a training symbol. In an embodiment, the training symbol is a preamble if the number of transmit antennas is equal to one. In another embodiment, the training symbol is a mid-amble, if the number of transmit antennas is at least two. In various embodiments, the mid-amble is a segmented or reuse-1 mid-amble.

CCI estimator 510 estimates CCI at each pilot sub-carrier of each symbol in a frame of the block transmission system wherein the frame is transmitted by at least one transmit antenna. In various embodiments, CCI estimator 510 comprises processor 530. Processor 530 is configured to determine the CCI at each pilot sub-carrier of a predetermined number of symbols (L) by using the channel response of the training symbol. In an embodiment, the predetermined number of symbols is equal to the periodicity of the pilot pattern of the frame. Processor 530 is further configured to estimate the CCI at each pilot sub-carrier of remaining symbols in the frame by using the CCI at each pilot sub-carrier of the predetermined number of symbols. This has been explained in detail above with reference to FIG. 3.

Symbol-channel-response calculator 515 calculates a channel response of each pilot sub-carrier of the remaining symbols of the frame based on the corresponding CCI estimated by CCI estimator 510.

Channel response updating module 520 updates the channel response of the pilot sub-carrier of the ‘k+L’ symbol based on the channel response of the corresponding pilot sub-carrier of a ‘k+L−1’ symbol. In an embodiment, the channel response is updated by carrying out time domain processing on the channel response of the corresponding pilot sub-carrier of the ‘k+L−1’ symbol. Time domain processing may include Inverse Fast Fourier Transform (IFFT) of the channel response of the corresponding pilot sub-carrier of the ‘k+L−1’ symbol, time domain windowing and truncation of the channel response of the corresponding pilot sub-carrier of the ‘k+L−1’ symbol to a predefined length and the like.

Co-channel interference updating module 525 updates the CCI of the pilot sub-carrier of the ‘k+L’ symbol based on the updated the channel response.

In an embodiment, training-channel-response estimator 505, CCI estimator 510 and symbol-channel-response calculator 515 are integrated into a single module.

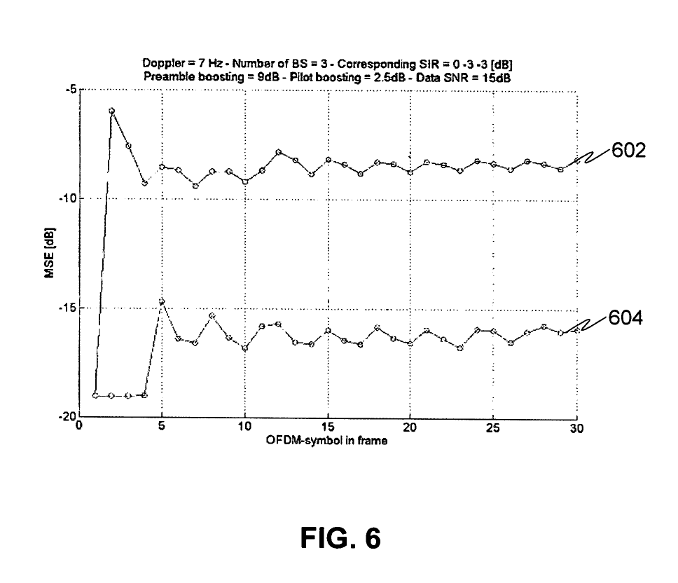

FIG. 6 is a comparison between the method of an embodiment described above (graph 602) and a conventional method known in the art (graph 604). The Mean Square Error (MSE) performance of the method described above and a representative conventional method known in the art, in the presence of severe interference contributed from two other undesired base stations, is shown in FIG. 6. The conventional method known in the art is a single channel estimator without interference cancellation. These graphs (graph 602 and graph 604) shows result of a representative simulation at Doppler of 7 Hz with interferences from two undesired base stations at a corresponding Signal to Interference Ratio (SIR) of 0.3-3 dB. Further, the preamble boosting was maintained at 9 dB and pilot boosting at 2.5 dB with data Signal to Noise Ratio (SNR) of 15 dB.

The various embodiments described above provide a method and system for estimating co-channel interference (CCI) at each pilot sub-carrier of each symbol in a frame of a block transmission system. As a result, the accuracy of the estimation of the channel response improves significantly.

What is claimed is:

1. A method for estimating co-channel interference at each pilot sub-carrier of each symbol in a frame of a block transmission system, the block transmission system being a frequency reuse system, the method comprising:
a. determining the co-channel interference at each pilot sub-carrier of a predetermined number of symbols (L), the predetermined number of symbols being equal to the periodicity of the pilot pattern of the frame; and
b. using the co-channel interference at each pilot sub-carrier of the predetermined number of symbols to estimate the co-channel interference at each pilot sub-carrier of remaining symbols in the frame.

2. The method of claim 1, wherein the co-channel interference at a pilot sub-carrier of a ‘k+L’ symbol is approximately equal to the co-channel interference at the corresponding pilot sub-carrier of a ‘k’ symbol.

3. The method of claim 1, wherein the frame is an uplink frame.

4. The method of claim 1, wherein the frame is a downlink frame.

5. A method for performing channel estimation, the channel estimation being performed by a receiver in a block transmission system, the block transmission system being a frequency reuse system, the method comprising:
a. estimating a channel response of a training symbol;
b. estimating co-channel interference at each pilot sub-carrier of each symbol in a frame of the block transmission system, the frame being transmitted by at least one transmit antenna, wherein estimating co-channel interference comprises:
i. determining the co-channel interference at each pilot sub-carrier of a predetermined number of symbols (L) by using the channel response of the training symbols, the predetermined number of symbols being equal to the periodicity of the pilot pattern of the frame; and
ii. using the co-channel interference at each pilot sub-carrier of the predetermined number of symbols to estimate the co-channel interference at each pilot sub-carrier of remaining symbols in the frame; and
c. calculating a channel response of each pilot sub-carrier of the remaining symbols of the frame based on the corresponding estimated co-channel interference.

6. The method of claim 5, wherein the training symbol is a preamble symbol if the number of transmit antennas is equal to one.

7. The method of claim 5, wherein the training symbol is a mid-amble symbol if the number of transmit antennas is at least two.

8. The method of claim 7, wherein the mid-amble is a reuse-⅓ mid-amble symbol.

9. The method of claim 5, wherein the co-channel interference at each pilot sub-carrier of the predetermined number of symbols (L) is determined using a product of the channel response of the training symbols and a predetermined function of fader rate of the receiver and difference in number of symbols from the training symbol.

10. The method of claim 5, wherein the co-channel interference at a pilot sub-carrier of a ‘k+L’ symbol is approximately equal to the co-channel interference at a corresponding pilot sub-carrier of a ‘k’ symbol.

11. The method of claim 5, wherein the co-channel interference at a pilot sub-carrier of a ‘k+L’ symbol is approximately equal to a product of the fader rate of the receiver and the co-channel interference at the corresponding pilot sub-carrier of a ‘k’ symbol.

12. The method of claim 10, further comprising:
a. updating the channel response of the pilot sub-carrier of the ‘k+L’ symbol based on the channel response of the corresponding pilot sub-carrier of a ‘k+L−1’ symbol; and
b. updating the co-channel interference of the pilot sub-carrier of the ‘k+L’ symbol based on the updated the channel response.

13. A system for performing channel estimation, the channel estimation being performed by a receiver in a block transmission system, the block transmission system being a frequency reuse system, the system comprising:
a. a training-channel-response estimator, the training-channel-response estimator configured to estimate a channel response of a training symbol;
b. a co-channel interference estimator, the co-channel interference estimator configured to estimate co-channel interference at each pilot sub-carrier of each symbol in a frame of the block transmission system, the frame being transmitted by at least one transmit antenna, wherein the co-channel interference estimator comprises a processor that is configured to:
i. determine the co-channel interference at each pilot sub-carrier of a predetermined number of symbols (L) by using the channel response of the training symbols, the predetermined number of symbols being equal to the periodicity of the pilot pattern of the frame; and
ii. use the co-channel interference at each pilot sub-carrier of the predetermined number of symbols to estimate the co-channel interference at each pilot sub-carrier of remaining symbols in the frame; and
c. a symbol-channel-response calculator, the symbol-channel-response calculator configured to calculate a channel response of each pilot sub-carrier of the remaining symbol of the frame based on the corresponding estimated co-channel interference.

14. The system of claim 13, wherein each pilot sub-carrier in the frame is a Maximum Length Shift Register (MLSR) sequence.

15. The system of claim 13, wherein the co-channel interference at a pilot sub-carrier of a ‘k+L’ symbol is approximately equal to the co-channel interference at the corresponding pilot sub-carrier of a ‘k’ symbol.

16. The system of claim 15, further comprising:
a. a channel response updating module configured to update the channel response of the pilot sub-carrier of the ‘k+L’ symbol based on the channel response of the corresponding pilot sub-carrier of a ‘k+L−1’ symbol; and
b. a co-channel interference updating module configured to update the co-channel interference of the pilot sub-carrier of the ‘k+L’ symbol based on the updated the channel response.

17. The system of claim 13, wherein the co-channel interference at a pilot sub-carrier of a ‘k+L’ symbol is approximately equal to the product of the fader rate of the receiver and the co-channel interference at the corresponding pilot sub-carrier of a ‘k’ symbol.

18. The system of claim 13, wherein the co-channel interference at each pilot sub-carrier of the predetermined number of symbols (L) is determined by using a product of the channel response of the training symbols and a predetermined function of fader rate of the receiver and difference in number of symbols from the training symbols.

19. The system of claim 13, wherein the block transmission system is a frequency reuse-1 system.

20. The system of claim 13, wherein the training-channel-response estimator, the co-channel interference estimator and the symbol-channel-response calculator are integrated into a single module.
